(19) United States
(12) Patent Application Publication
(10) Pub. No.: US 2019/0264136 A1
(43) Pub. Date: Aug. 29, 2019

(54) FABRIC ENHANCER COMPOSITION

(71) Applicant: The Procter & Gamble Company, Cincinnati, OH (US)

(72) Inventors: Marc Johan DECLERCQ, Strombeek-bever (BE); Pieter Jan Maria SAVEYN, Heusden (BE); Dries VAES, Houtvenne (BE); Timothy J. YOUNG, Bay City, MI (US)

(21) Appl. No.: 16/281,174

(22) Filed: Feb. 21, 2019

Related U.S. Application Data
(60) Provisional application No. 62/636,301, filed on Feb. 28, 2018.

(51) Int. Cl. C11D 3/00; C11D 1/835; C11D 1/62; C11D 1/72

(52) U.S. Cl. CPC C11D 3/0015; C11D 1/72; C11D 1/62; C11D 1/835

(57) ABSTRACT

The present invention relates to fabric enhancer compositions as well as the methods of making and using same. Such fabric enhancer compositions comprise a quaternary ammonium ester fabric softening active, a branched, ethoxylated nonionic surfactant and perfume. Such fabric enhancer compositions exhibit improved freeze than stability while also delivering the softening benefits that are desired by consumers.

### FIELD OF THE INVENTION

The present invention relates to fabric enhancer compositions as well as the methods of making and using same.

### BACKGROUND OF THE INVENTION

Liquid fabric enhancers comprising quaternary ammonium ester softening actives can exhibit freeze-thaw instability that typically results in product gelling. While certain solutions to such instability have been proposed, such solutions are not entirely acceptable as they give rise to other issues such as increased formulation complexity and cost. Furthermore, such solutions do not work universally for a broad set of different liquid fabric enhancer compositions. As such, greater formulation effort is needed when reformulating fabric enhancer compositions, in order to ensure they remain freeze-thaw stable. Applicants recognized that the source of the problem was rooted in the disruption of the quaternary ammonium ester vesicles during the freeze thaw cycle which results in the formation of lamellar sheets that induce a dramatic viscosity increase. The increased viscosity is typically so dramatic that the product is no longer fit for use. The freeze-thaw instability is particularly pronounced in the presence of perfume. While not being bound by theory, Applicants believe that in order to provide a universal solution to the aforementioned problem, a nonionic surfactant comprising a hydrophobic moiety and hydophillic moiety that universally results in a sufficient balanced interaction with the quaternary ammonium ester vesicles is required to inhibt the aforementioned transition from vesicles to lamellar sheets. Thus, Applicants disclose liquid fabric enhancer formulations that have a freeze-thaw stability over a broad range of liquid fabric enhancer actives.

### SUMMARY OF THE INVENTION

The present invention relates to fabric enhancer compositions as well as the methods of making and using same. Such fabric enhancer compositions comprise a quaternary ammonium ester fabric softening active, a branched, ethoxylated nonionic surfactant, perfume, and an alcohol. Such fabric enhancer compositions exhibit improved freeze-thaw stability while also delivering the softening and freshness benefits that are desired by consumers.

### BRIEF DESCRIPTION OF THE DRAWINGS

FIG. 1 details the apparatus A used in the process of the present invention

FIG. 2 details the orifice component 5 of the apparatus used in the method of the present invention

FIG. 3 details the apparatus B used in the process of the present invention

### DETAILED DESCRIPTION OF THE INVENTION

### Definitions

As used herein, the phrase “benefit agent containing delivery particle” encompasses microcapsules including perfume microcapsules.

As used herein, the articles including “a” and “an” when used in a claim, are understood to mean one or more of what is claimed or described.

As used herein, the terms “include”, “includes” and “including” are meant to be non-limiting.

The test methods disclosed in the Test Methods Section of the present application should be used to determine the respective values of the parameters of Applicants' inventions.

Unless otherwise noted, all component or composition levels are in reference to the active portion of that component or composition, and are exclusive of impurities, for example, residual solvents or by-products, which may be present in commercially available sources of such components or compositions. For example, it is known that quaternary ammonium esters typically contain the following impurities: the monoester form of the quaternary ammonium ester, residual non-reacted fatty acid, and non-quaternized esteramines.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### The Fabric Enhancer Composition and Method of Use

I. A fabric enhancer composition having a viscosity of from 20 cP to 700 cP, preferably 40 cP to 600 cP, more preferably 60 cP to 400 cP and a pH of from about 1 to about 5, preferably from about 2 to about 4, said fabric enhancer composition comprising, based on total composition weight:
   a) from about 3% to about 20%, preferably from about 4% to about 15%, more preferably from about 6% to about 12% of a quaternary ammonium ester fabric softening active;
   b) from about 0.01% to about 30%, from about 0.1% to about 30%, more preferably from about 0.5% to about 15%, more preferably from about 1% to about 10%, most preferably from about 2% to about 9% of an alcohol comprising from 1 to 7 carbons, preferably said alcohol is selected from the group consisting of a mono alcohol, polyol and mixtures thereof; more preferably said alcohol is selected from the group consisting of ethanol, isopropanol, glycerol, ethylene glycol, propanediol, sorbitol and mixtures thereof; most preferably, said alcohol is selected from the group consisting of glycerol, ethylene glycol, propanediol, sorbitol and mixtures thereof; and
   c) from about 0.1% to about 10% of a perfume delivery system and/or from about 0.1% to about 4% perfume
   d) a surfactant having Formula A and/or B, preferably Formula A:

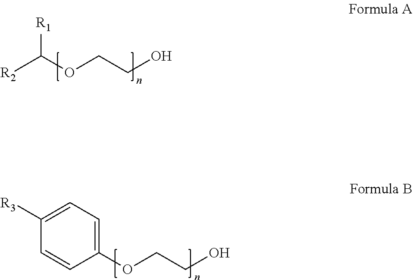

wherein n is on average greater than 15 and smaller than 30, preferably from about 16 to 29, more preferably from about 18-29, most preferably n is 20; R₁ is a linear or branched alkyl group comprising from 1 to 21 carbons, or R₁ is a hydrogen; R₂ is a linear or branched alkyl group comprising from 1 to 22 carbon atoms, with the proviso that the sum of the total number of carbon atoms of R₁ and R₂ is from 9 to 22; with the proviso that when R₁ is a hydrogen, R₂ is a branched alkyl group;
preferably, R₃ is a branched alkyl group comprising 9 carbon atoms;
the ratio of quaternary ammonium ester softener active to nonionic surfactant being 1:1 to 20:1, preferably, 1:1 to 10:1, more preferably 2:1 to 13:2;
preferably said fabric enhancer composition comprises, based on total composition weight, from 1.1% to about 5%, more preferably from 1.2% to about 3%, most preferably from 1.2% to about 2% of said nonionic surfactant;

is disclosed.

Examples of suitable commercially quaternary ammonium ester fabric softening actives are available from KAO Chemicals under the trade name Tetranyl AT-1 and Tetranyl AT-7590, from Evonik under the tradename Rewoquat WE16 DPG, Rewoquat WE18, Rewoquat WE20, Rewoquat WE28, and Rewoquat 38 DPG, from Stepan under the tradename Stepantex GA90, Stepantex VR90, Stepantex VK90, Stepantex VA90, Stepantex DC90, Stepantex VL90A.

The average degree of ethoxylation of surfactants is represented by n and with the average degree of ethoxylation we herein mean the stoichiometric number of ethylene oxide molecules reacted per molecule of fatty alcohol.

Examples of suitable commercially available nonionic ethoxylated surfactants with the structure of Formula A are available from The Dow Chemical Company under the trade name Tergitol™ 15-s-20 wherein n is 20.
II. A fabric enhancer composition according to Paragraph I wherein said fabric softening active quaternary ammonium ester has the following formula:

{R²₄₋ₘ—N⁺—[X—Y—R¹]ₘ}A⁻

wherein:
m is 1, 2 or 3 with proviso that the value of each m is identical;
each R¹ is independently hydrocarbyl, or substituted hydrocarbyl group;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently (CH₂)n, CH₂—CH(CH₃)— or CH—(CH₃)—CH₂— and
each n is independently 1, 2, 3 or 4, preferably each n is 2;
each Y is independently —O—(O)C— or —C(O)—O—;
A− is independently selected from the group consisting of chloride, methylsulfate, ethylsulfate, and sulfate, preferably A− is selected from the group consisting of chloride and methyl sulfate;
   with the proviso that the sum of carbons in each R¹, when Y is —O—(O)C—, is from 13 to 21, preferably the sum of carbons in each R¹, when Y is —O—(O)C—, is from 13 to 19.
III. A fabric enhancer composition according to any of Paragraphs I-II wherein said quaternary ammonium ester fabric softening active comprises a fatty acid moiety comprising 12 to 22 carbons, said quaternary ammonium esters being selected from the group consisting of:
   a) bis-(2-hydroxypropyl)-dimethylammonium methylsulfate fatty acid ester;
   b) isomers of bis-(2-hydroxypropyl)-dimethylammonium methylsulfate fatty acid ester;
   c) N,N-bis(hydroxethyl)-N,N-dimethyl ammonium chloride fatty acid ester;
   d) N,N-bis(hydroxyethyl)-N,N-dimethyl ammonium methylsulfate fatty acid ester; and
   e) N,N,N-tri(2-hydroxyethyl)-N-methyl ammonium methylsulfate fatty acid ester;
      said quaternary ammonium ester fabric softening active's fatty acid ester moiety being saturated or unsaturated, and substituted or unsubstituted.
IV. A fabric enhancer composition according to any of Paragraphs I-III wherein said quaternary ammonium ester fabric softening active is:
   a) saturated, substituted and of animal origin;
   b) saturated, substituted and of vegetable origin;
   c) saturated, unsubstituted and of animal origin;
   d) saturated, unsubstituted and of vegetable origin;
   e) unsaturated, substituted and of animal origin;
   f) unsaturated, substituted and of vegetable origin;
   g) unsaturated, unsubstituted and of animal origin; or
   h) unsaturated, unsubstituted and of vegetable origin
   preferably said quaternary ammonium ester fabric softening active has an iodine value from 0 to about 60, more preferably from about 10 to about 55, most preferably from about 15 to about 45.
V. A fabric enhancer composition according to any of Paragraphs I-IV wherein said quaternary ammonium ester fabric softening active has the following formula:

{[R²]₂N⁺[CH₂—CH(CH₃)—O—C(═O)—R¹]₂}A⁻
wherein each R² is independently hydrogen, a short chain C₁-C₆ alkyl, C₁-C₃ hydroxyalkyl group, a poly(C₂₋₃ alkoxy), benzyl, or mixtures thereof,
wherein each IV is independently a hydrocarbyl group or substituted hydrocarbyl group comprising about 11 to about 21 carbon atoms,
and wherein A⁻ is selected from the group consisting of chloride and methylsulfate.
VI. A fabric enhancer composition according to any Paragraphs I-V, wherein said perfume delivery system is selected from the group consisting of benefit agent delivery particles, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof; preferably said perfume delivery system comprises benefit agent containing delivery particles, more preferably said perfume delivery system comprises two or more types of benefit agent containing delivery particles.
VII. A fabric enhancer composition according to any Paragraphs I-VI comprising an adjunct material.
VIII. A method of treating and/or cleaning a fabric, said method comprising
   a) optionally washing, rinsing and/or drying said fabric;
   b) contacting said fabric with a fabric enhancer composition according to any Paragraphs I-VII and
   c) optionally washing, rinsing and/or drying said fabric wherein said drying steps comprise active drying and/or passive drying.

### Use of Surfactant

Use of a surfactant having Formula A and/or B:

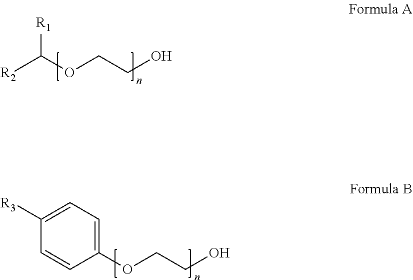

wherein n is on average greater than 15 and smaller than 30, preferably from about 16 to 29, more preferably from about 18-29, most preferably n is 20; R₁ is a linear or branched alkyl group comprising from 1 to 21 carbons; R₂ is a linear or branched alkyl group comprising from 1 to 22 carbon atoms, with the proviso that the sum of the total number of carbon atoms of R₁ and R₂ is from 9 to 22; preferably, n on average is 20 and the number of carbon atoms in both R₁ and R₂ is greater than 1; R₃ is a linear or branched alkyl group comprising from 9 to 22 carbon atoms; preferably R₃ is a branched alkyl group comprising 9 carbon atoms to improve the freeze than stability of a fabric enhancer composition is disclosed.

### Adjunct Ingredients

The fabric enhancer composition may comprise adjunct ingredients suitable for use in the instant compositions and may be desirably incorporated in certain aspects of the invention, for example to assist or enhance treatment of the substrate, or to modify the aesthetics of the composition as is the case with perfumes, colorants, dyes or the like. The precise nature of these additional components, and levels of incorporation thereof, will depend on the physical form of the composition and the nature of the fabric treatment operation for which it is to be used. Suitable adjunct materials include, but are not limited to, additional softener actives, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, carriers, structurants, hydrotropes, processing aids, solvents and/or pigments.

As stated, the adjunct ingredients are not essential to Applicants' compositions. Thus, certain aspects of Applicants' compositions do not contain one or more of the following adjuncts materials: additional softener actives, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems structure elasticizing agents, carriers, hydrotropes, processing aids, solvents and/or pigments. However, when one or more adjuncts are present, such one or more adjuncts may be present as detailed below.

### Additional Fabric Softening Active

The fluid fabric enhancer composition of the present invention may comprise from 0% to 10%, preferably from 0.1% to 10%, more preferably from 0.1% to 5% of additional fabric softening active (“FSA”). Suitable fabric softening actives, include, but are not limited to, materials selected from the group consisting of non-ester quaternary ammonium compounds, amines, fatty esters, sucrose esters, silicones, dispersible polyolefins, polysaccharides, fatty acids, softening oils, polymer latexes and combinations thereof.

Surfactants—The compositions according to the present invention may comprise in addition to the nonionic surfactant of Formula A or B, a surfactant or surfactant system not having formula A or B wherein the surfactant can be selected from nonionic surfactants, anionic surfactants, cationic surfactants, ampholytic surfactants, zwitterionic surfactants, semi-polar nonionic surfactants and mixtures thereof.

The surfactant is typically present at a level of from about 0.1% to about 60%, from about 1% to about 50% or even from about 5% to about 40% by weight of the subject composition.

Chelating Agents—The composition may contain a chelating agent. Suitable chelating agents include copper, iron and/or manganese chelating agents and mixtures thereof. When a chelating agent is used, the composition may comprise from about 0.1% to about 15% or even from about 3.0% to about 10% chelating agent by weight of the subject composition.

Dye Transfer Inhibiting Agents—The composition may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in a subject composition, the dye transfer inhibiting agents may be present at levels from about 0.0001% to about 10%, from about 0.01% to about 5% or even from about 0.1% to about 3% by weight of the composition.

Dispersants—The composition can also contain dispersants. Suitable water-soluble organic materials include the homo- or co-polymeric acids or their salts, in which the polycarboxylic acid comprises at least two carboxyl radicals separated from each other by not more than two carbon atoms.

Perfumes—The perfume composition may comprise from 2.5% to 30%, preferably from 5% to 30% of perfume raw materials characterized by a ClogP lower than 3.0, and a boiling point lower than 250° C., from 5% to 30%, preferably from 7% to 25% of perfume raw material characterized by a ClogP lower than 3.0 and a boiling point higher than 250° C., from 35% to 60%, preferably from 40% to 55% of perfume raw materials characterized by a ClogP higher than 3.0 and a boiling point lower than 250° C., from 10% to 45%, preferably from 12% to 40% of perfume raw materials characterized by ClogP higher than 3.0 and a boiling point higher than 250° C.

The “calculated logP” (ClogP) is determined by the fragment approach of Hansch and Leo (cf., A. Leo, in Comprehensive Medicinal Chemistry, Vol. 4, C. Hansch, P. G. Sammens, J. B. taylor, and C. A. Ramsden, Eds. P. 295, Pergamon Press, 1990).

Encapsulated Benefit Agent

The liquid fabric softener composition may comprise encapsulated benefit agent. Capsules encapsulating benefit agent comprise an outer shell defining an inner space in which a benefit agent is held until rupture of the shell.

The shell of the capsules may include a shell material. The shell material may include a material selected from the group consisting of polyethylenes; polyamides; polystyrenes; polyisoprenes; polycarbonates; polyesters; polyacrylates; acrylics; aminoplasts; polyolefins; polysaccharides, such as alginate and/or chitosan; gelatin; shellac; epoxy resins; vinyl polymers; water insoluble inorganics; silicone; and mixtures thereof. Preferably the shell material comprises polyacrylate to reduce leakage from the capsules.

The shell material of the capsules may include a polymer derived from a material that comprises one or more multifunctional acrylate moieties. The multifunctional acrylate moiety may be selected from the group consisting of tri-functional acrylate, tetra-functional acrylate, penta-functional acrylate, hexa-functional acrylate, hepta-functional acrylate and mixtures thereof. The multifunctional acrylate moiety is preferably hexa-functional acrylate. The shell material may include a polyacrylate that comprises a moiety selected from the group consisting of an acrylate moiety, methacrylate moiety, amine acrylate moiety, amine methacrylate moiety, a carboxylic acid acrylate moiety, carboxylic acid methacrylate moiety and combinations thereof, preferably an amine methacrylate or carboxylic acid acrylate moiety.

The shell material may include a material that comprises one or more multifunctional acrylate and/or methacrylate moieties. The ratio of material that comprises one or more multifunctional acrylate moieties to material that comprises one or more methacrylate moieties may be from about 999:1 to about 6:4, preferably from about 99:1 to about 8:1, more preferably from about 99:1 to about 8.5:1.

The core/shell capsule may comprise an emulsifier, wherein the emulsifier is preferably selected from anionic emulsifiers, nonionic emulsifiers, cationic emulsifiers or mixtures thereof, preferably nonionic emulsifiers.

The core/shell capsule may comprise from 0.1% to 1.1% by weight of the core/shell capsule of polyvinyl alcohol. Preferably, the polyvinyl alcohol has at least one the following properties, or a mixture thereof:
a hydrolysis degree from 55% to 99%;
(ii) a viscosity of from 40 mPa.s to 120 mPa.s in 4% water solution at 20° C.;
(iii) a degree of polymerization of from 1,500 to 2,500;
(iv) number average molecular weight of from 65,000 Da to 110,000 Da.

The core/shell capsule may comprise an emulsifier, wherein the emulsifier is preferably selected from styrene maleic anhydride monomethylmaleate, and/or a salt thereof, in one aspect, styrene maleic anhydride monomethylmaleate di-sodium salt and/or styrene maleic anhydride monomethylmaleate ammonia-salt; in one aspect, said styrene maleic anhydride monomethylmaleate, and/or a salt thereof.

Perfume compositions are the preferred encapsulated benefit agent. The perfume composition comprises perfume raw materials. The encapsulated benefit agent may further comprise essential oils, malodour reducing agents, odour controlling agents, silicone, and combinations thereof.

The perfume raw materials are typically present in an amount of from 10% to 95%, preferably from 20% to 90% by weight of the capsule.

The perfume composition may comprise from 2.5% to 30%, preferably from 5% to 30% by weight of perfume composition of perfume raw materials characterized by a logP lower than 3.0, and a boiling point lower than 250° C.

The perfume composition may comprise from 5% to 30%, preferably from 7% to 25% by weight of perfume composition of perfume raw materials characterized by having a logP lower than 3.0 and a boiling point higher than 250° C. The perfume composition may comprise from 35% to 60%, preferably from 40% to 55% by weight of perfume composition of perfume raw materials characterized by having a logP higher than 3.0 and a boiling point lower than 250° C.

The perfume composition may comprise from 10% to 45%, preferably from 12% to 40% by weight of perfume composition of perfume raw materials characterized by having a logP higher than 3.0 and a boiling point higher than 250° C.

Preferably, the core also comprises a partitioning modifier. Suitable partitioning modifiers include vegetable oil, modified vegetable oil, propan-2-yl tetradecanoate and mixtures thereof. The modified vegetable oil may be esterified and/or brominated. The vegetable oil comprises castor oil and/or soy bean oil. The partitioning modifier may be propan-2-yl tetradecanoate. The partitioning modifier may be present in the core at a level, based on total core weight, of greater than 20%, or from greater than 20% to about 80%, or from greater than 20% to about 70%, or from greater than 20% to about 60%, or from about 30% to about 60%, or from about 30% to about 50%.

Preferably the core/shell capsule have a volume weighted mean particle size from 0.5 microns to 100 microns, preferably from 1 micron to 60 microns, even more preferably from 5 microns to 30 microns.

### Method of Use

The compositions of the present invention may be used in any conventional manner In short, they may be used in the same manner as products that are designed and produced by conventional methods and processes. For example, compositions of the present invention can be used to treat a situs inter alia a surface or fabric. Typically at least a portion of the situs is contacted with an aspect of Applicants' composition, in neat form or diluted in a wash liquor, and then the situs is optionally washed and/or rinsed. For purposes of the present invention, washing includes but is not limited to, scrubbing, and mechanical agitation. The fabric may comprise any fabric capable of being laundered in normal consumer use conditions. When the wash solvent is water, the water temperature typically ranges from about 5° C. to about 90° C. and, when the situs comprises a fabric, the water to fabric mass ratio is typically from about 1:1 to about 100:1.

The consumer products of the present invention may be used as liquid fabric enhancers wherein they are applied to a fabric and the fabric is then dried via line drying and/or drying the an automatic dryer.

### Methods

### Method of Determining pH

The pH is measured on the neat composition, at about 20-21° C., using a Sartarius PT-10P pH meter with gel-filled probe (such as the Toledo probe, part number 52 000 100), calibrated according to the instructions manual.

### Method of Determining Viscosity

The viscosity of neat product is determined using a Brookfield® DV-E rotational viscometer, spindle 2, at 60 rpm, at about 20-21° C.

### Method of Determining Partition Coefficient

The partition coefficient, P, is the ratio of concentrations of a compound in a mixture of two immiscible phases at equilibrium, in this case n-Octanol/Water. The value of the log of the n-Octanol/Water Partition Coefficient (logP) can be measured experimentally using well known means, such as the “shake-flask” method, measuring the distribution of the solute by UV/VIS spectroscopy (for example, as described in “The Measurement of Partition Coefficients”, Molecular Informatics, Volume 7, Issue 3, 1988, Pages 133-144, by Dearden J C, Bresnan). Alternatively, the logP can be computed for each PRM in the perfume mixture being tested. The logP of an individual PRM is preferably calculated using the Consensus logP Computational Model, version 14.02 (Linux) available from Advanced Chemistry Development Inc. (ACD/Labs) (Toronto, Canada) to provide the unitless logP value. The ACD/Labs' Consensus logP Computational Model is part of the ACD/Labs model suite.

### Method of Measuring Iodine Value of a Quaternary Ammonium Ester Fabric Softening Active:

The iodine value (“IV”) of a quaternary ammonium ester fabric softening active is the iodine value of the parent fatty acid from which the fabric softening active is formed, and is defined as the number of grams of iodine which react with 100 grams of parent fatty acid from which the fabric softening active is formed.

First, the quaternary ammonium ester fabric softening active is hydrolysed according to the following protocol: 25 g of fabric softener composition is mixed with 50 mL of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric softening active is formed is determined following ISO3961:2013. The method for calculating the iodine value of a parent fatty acid comprises dissolving a prescribed amount (from 0.1-3 g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

Freeze-thaw cycle:

The viscosity of the Fabric enhancer compositions is measured 24 hrs after making and after a freeze-thaw (F/T) cycle to assess their robustness under extreme cold temperatures. The freeze-thaw cycle procedure consists of filling a 200 mL glass jar with 150 mL of the Fabric enhancer composition, closing the jar with a metal lid, putting the filled glass jar in a freezer at −18° C. for 4 consecutive days. After 4 days, the sample is taken out of the freezer and left to recover by exposing it at a temperature of 20-21° C. After 3 consecutive days at 20-21° C., the viscosity is measured again. This viscosity is referred to as the viscosity after a F/T cycle.

### Processes of Making the Fabric Softener Composition of the Invention

The compositions of the present invention can be formulated into any suitable form and prepared by any process chosen by the formulator, non-limiting examples of which are described in Applicant's examples and in US 2013/0109612 A1 which is incorporated herein by reference.

The compositions disclosed herein may be prepared by combining the components thereof in any convenient order and by mixing, e.g., agitating, the resulting component combination to form a phase stable fabric care composition. A fluid matrix may be formed containing at least a major proportion, or even substantially all, of the fluid components with the fluid components being thoroughly admixed by imparting shear agitation to this liquid combination. For example, rapid stirring with a mechanical stirrer may be employed.

The liquid fabric softener compositions described herein can also be made as follows:

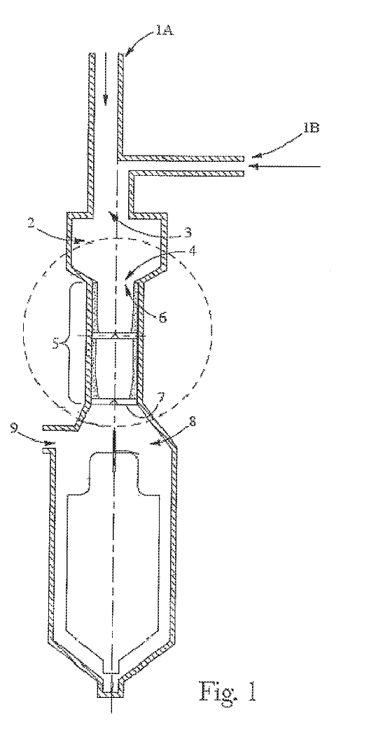

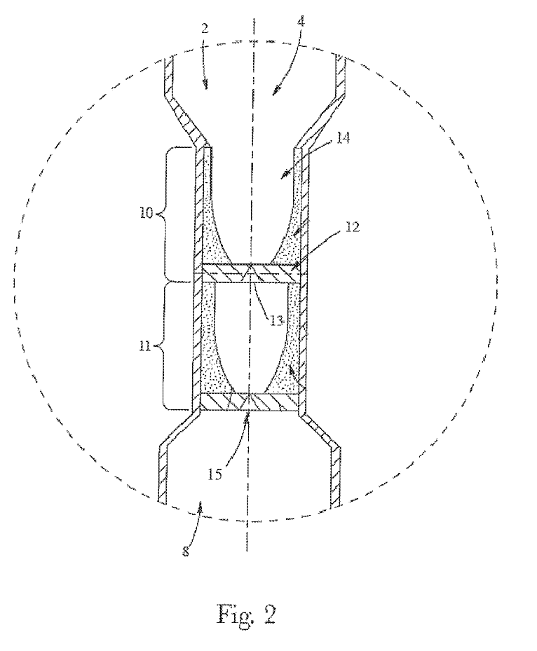

Taking an apparatus A (see FIG. 1) comprising: at least a first inlet 1A and a second inlet 1B; a pre-mixing chamber 2, the pre-mixing chamber 2 having an upstream end 3 and a downstream end 4, the upstream end 3 of the pre-mixing chamber 2 being in liquid communication with the first inlet 1A and the second inlet 1B; an orifice component 5, the orifice component 5 having an upstream end 6 and a downstream end 7, the upstream end of the orifice component 6 being in liquid communication with the downstream end 4 of the pre-mixing chamber 2, wherein the orifice component 5 is configured to spray liquid in a jet and produce shear and/or turbulence in the liquid; a secondary mixing chamber 8, the secondary mixing chamber 8 being in liquid communication with the downstream end 7 of the orifice component 5; at least one outlet 9 in liquid communication with the secondary mixing chamber 8 for discharge of liquid following the production of shear and/or turbulence in the liquid, the inlet 1A, pre-mixing chamber 2, the orifice component 5 and secondary mixing chamber 8 are linear and in straight line with each other, at least one outlet 9 being located at the downstream end of the secondary mixing chamber 8; the orifice component 5 comprising at least one orifice unit, a specific example, as shown in FIG. 2, is that the orifice component 5 comprises two orifice units 10 and 11 arranged in series to one another and each orifice unit comprises an orifice plate 12 comprising at least one orifice 13, an orifice chamber 14 located upstream from the orifice plate 12 and in liquid communication with the orifice plate 12; and wherein neighboring orifice plates are distinct from each other;

connecting one or more suitable liquid pumping devices to the first inlet 1A and to the second inlet 1B;

pumping a second liquid composition into the first inlet 1A, and, pumping a liquid fabric softener active composition into the second inlet 1B, wherein the operating pressure of the apparatus is from 2.5 bar to 50 bar, from 3.0 bar to 20 or from 3.5 bar to 10 bar the operating pressure being the pressure of the liquid as measured in the first inlet 1A near to inlet 1B. The operating pressure at the outlet of apparatus A needs to be high enough to prevent cavitation in the orifice;

allowing the liquid fabric softener active and the second liquid composition to pass through the apparatus A at a desired flow rate, wherein as they pass through the apparatus A, they are dispersed one into the other, herein, defined as a liquid fabric softener intermediate.

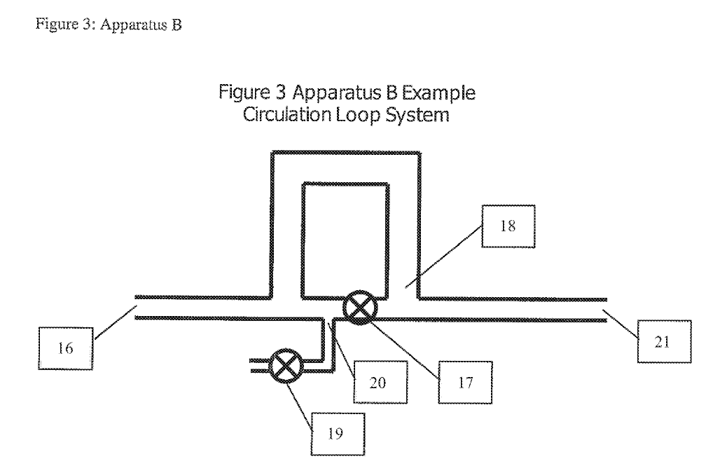

passing said liquid fabric softener intermediate from Apparatus A's outlet, to Apparatus B's (FIG. 3) inlet 16 to subject the liquid fabric softener intermediate to additional shear and/or turbulence for a period of time within Apparatus B.

circulating said liquid fabric softener intermediate within apparatus B with a circulation Loop pump 17 at a Circulation Loop 18 Flow Rate equal to or greater than said inlet liquid fabric softener intermediate flow rate in said Circulation Loop System. A tank, with or without a recirculation loop, or a long conduit may also be employed to deliver the desired shear and/or turbulence for the desired time.

adding by means of a pump 19, piping and in-line fluid injector 20, an adjunct fluid, in one aspect, but not limited to a dilute salt solution, into Apparatus B to mix with the liquid fabric softener intermediate

allowing the liquid fabric softener composition with the desired microstructure to exit Apparatus B 21 at a rate equal to the inlet flow rate into Apparatus B.

passing said liquid fabric softener composition exiting Apparatus B outlet through a heat exchanger to be cooled to ambient temperature, if necessary.

discharging the resultant liquid fabric softener composition produced out of the outlet of the process.

The process comprises introducing, in the form of separate streams, the fabric softener active in a liquid form and a second liquid composition comprising other components of a fabric softener composition into the pre-mixing chamber 2 of Apparatus A so that the liquids pass through the orifice component 5. The fabric softener active in a liquid form and the second liquid composition pass through the orifice component 5 under pressure. The fabric softener active in liquid form and the second liquid composition can be at the same or different operating pressures. The orifice component 5 is configured, either alone, or in combination with some other component, to mix the liquid fabric softener active and the second liquid composition and/or produce shear and/or turbulence in each liquid, or the mixture of the liquids.

The liquids can be supplied to the apparatus A and B in any suitable manner including, but not limited to through the use of pumps and motors powering the same. The pumps can supply the liquids to the apparatus A under the desired operating pressure. In one embodiment, an ‘8 frame block-style manifold’ is used with a 781 type Plunger pump available from CAT pumps (1681 94th Lane NE, Minneapolis, Minn. 55449).

The operating pressure of conventional shear and/or turbulence apparatuses is typically between 2 bar and 490 bar. The operating pressure is the pressure of the liquid in the inlet 1A near inlet 1B. The operating pressure is provided by the pumps. The operating pressure of Apparatus A is measured using a Cerphant T PTP35 pressure switch with a RVS membrane, manufactured by Endress Hauser (Endress+Hauser Instruments, International AG, Kaegenstrasse 2, CH-4153, Reinach). The switch is connected with the inlet 1A near inlet 1B using a conventional thread connection (male thread in the pre-mix chamber housing, female thread on the Cerphant T PTP35 pressure switch).

The operating pressure of Apparatus A may be lower than conventional shear and/or turbulence processes, yet the same degree of liquid mixing is achievable as seen with processes using conventional apparatuses. Also, at the same operating pressures, the process of the present invention results in better mixing than is seen with conventional shear and/orturbulence processes.

As the fabric softener active and the second liquid composition flow through the Apparatus A, they pass through the orifices 13 and 15 of the orifice component 5. As they do, they exit the orifice 13 and/or 15 in the form of a jet. This jet produces shear and/or turbulence in the fabric softener active and the second liquid composition, thus dispersing them one in the other to form a uniform mixture.

In conventional shear and/or turbulence processes, the fact that the liquids are forced through the orifice 13 and/or 15 under high pressure causes them to mix. This same degree of mixing is achievable at lower pressures when the liquids are forced through a series of orifices, rather than one at a high pressure. Also, at equivalent pressures, the process of the present invention results in better liquid mixing than shear and/or turbulence processes, due to the fact that the liquids are now forced through a series of orifices.

A given volume of liquid can have any suitable residence time and/or residence time distribution within the apparatus A. Some suitable residence times include, but are not limited to from 1 microsecond to 1 second, or more. The liquid(s) can flow at any suitable flow rate through the apparatus A. Suitable flow rates range from 1 to 1 500 L/min, or more, or any narrower range of flow rates falling within such range including, but not limited to from 5 to 1 000 L/min

For Apparatus B Circulating Loop System example, one may find it convenient to characterize the circulation flow by a Circulation Loop Flow Rate Ratio which is equal to the Circulation Flow Rate divided by the Inlet Flow Rate. Said Circulation Loop Flow Rate Ratio for producing the desired fabric softener composition microstructure can be from 1 to 100, from 1 to 50, and even from 1 to 20. The fluid flow in the circulation loop imparts shear and turbulence to the liquid fabric softener to transform the liquid fabric softener intermediate into a desired dispersion microstructure.

The duration of time said liquid fabric softener intermediate spends in said Apparatus B may be quantified by a Residence Time equal to the total volume of said Circulation Loop System divided by said fabric softener intermediate inlet flow rate. Said Circulation Loop Residence Time for producing desirable liquid fabric softener composition microstructures may be from 0.1 seconds to 10 minutes, from 1 second to 1 minute, or from 2 seconds to 30 seconds. It is desirable to minimize the residence time distribution.

Shear and/or turbulence imparted to said liquid fabric softener intermediate may be quantified by estimating the total kinetic energy per unit fluid volume. The kinetic energy per unit volume imparted in the Circulation Loop System to the fabric softener intermediate in Apparatus B may be from 10 to 1 000 000 g.cm−1.s−2, from 50 to 500 000 g.cm−1.s−2, or from 100 to 100 000 g.cm−1.s−2. The liquid(s) flowing through Apparatus B can flow at any suitable flow rate. Suitable inlet and outlet flow rates range from 1 to 1 500 L/min, or more, or any narrower range of flow rates falling within such range including, but not limited to from 5 to 1 000 L/min. Suitable Circulation Flow Rates range from 1 L/min to 20 000 L/min or more, or any narrower range of flow rates falling within such range including but not limited to from 5 to 10 000 L/min. Apparatus A is ideally operated at the same time as Apparatus B to create a continuous process. The liquid fabric softener intermediate created in Apparatus A may also be stored in a suitable vessel and processed through apparatus B at a later time.

### EXAMPLES

Examples 1-5: Fabric Enhancer Compositions

Fabric enhancer compositions were prepared by first preparing a dispersion of the quaternary ammonium ester softener active (“FSA”) using Apparatus A and B in a continuous fluid making process with 3 orifices. Heated FSA at 81° C. and heated deionized water at 65° C. containing adjunct materials NaHEDP chelant, HCl, formic acid, and the preservative were fed using positive displacement pumps, through Apparatus A, and through Apparatus B, a circulation loop fitted with a centrifugal pump. The liquid fabric softener composition was immediately cooled to 25° C. with a plate heat exchanger. The total flow rate was 3.1 Kg/min; pressure at Apparatus A Inlet was 5 bar; pressure at Apparatus A Outlet was 2.5 bar; Apparatus B Circulation Loop Flow rate Ratio 8.4; Apparatus B Kinetic Energy 18000 g.cm−1.s−2; Apparatus B Residence Time 14 s; Apparatus B Outlet pressure was 3 bar.

The fabric enhancer compositions are finished by adding the remaining ingredients provided in Table 1 below to the dispersions described in the paragraph above using a Ytron-Y high speed mixer operated at 20 Hz for 15-20 minutes. Table 1 shows the overall composition of Examples 1-5. With the exception of the nonionic surfactant level, the ingredients are added as received. For example, in Example 1 below the preservative is added at an actual, as received from the supplier level of 0.020% while the active ingredient 1,2-benzisothiazolin-3-one is present in the preservative solution at a level of 20%. The nonionic surfactant level refers to the actual level of nonionic surfactant based on 100% activity. Examples 5 illustrates the invention. The remaining examples 1-4 are comparative examples indicated with an asterisk.

TABLE 1
Fabric enhancer composition examples 1 through 5. The examples
marked with an asterisk are comparative examples.

| | Ex 1* | Ex 2* | Ex 3* | Ex 4* | Ex 5 |
|---|---|---|---|---|---|
| DI water | Balance | Balance | Balance | Balance | Balance |
| NaHEDP | 0.0064 | 0.0064 | 0.0064 | 0.0064 | 0.0064 |
| Formic acid | 0.040 | 0.040 | 0.040 | 0.040 | 0.022 |
| HCl | 0.0180 | 0.0180 | 0.0180 | 0.0180 | 0.027 |
| Preservative^{a} | 0.020 | 0.020 | 0.020 | 0.020 | 0.020 |
| FSA^{b} | 7.2 | 7.2 | 7.2 | 7.2 | 7.2 |
| Antifoam^{c} | 0.091 | 0.091 | 0.091 | 0.091 | 0.007 |
| CaCl₂ | 0.02 | 0.02 | 0.02 | 0.02 | 0.013 |
| Encapsulated perfume^{d} | 0.14 | 0.14 | 0.14 | 0.14 | 0.14 |
| Dye | 0.0100 | 0.0100 | 0.0100 | 0.0100 | 0.0100 |
| Polymeric thickener^{e} | 0.15 | 0.15 | 0.15 | 0.15 | 0.15 |
| Glycerol | 7.6 | 7.6 | 7.6 | 7.6 | 7.6 |
| Nonionic surfactant type | Lorodac | Emulan | Tergitol | Tergitol | Tergitol |
| | 20-24 | HE 50 | 15-S-7 | 15-S-15 | 15-S-20 |
| Nonionic surfactant^{f} | 1.2 | 1.2 | 1.2 | 1.2 | 1.2 |
| Perfume oil | 0.52 | 0.52 | 0.52 | 0.52 | 0.52 |
| Ratio quaternary ammonium | 6.0 | 6.0 | 6.0 | 6.0 | 6.0 |
| FSA/nonionic surfactant | | | | | |
| Viscosity after 24 hr [cP]^{g} | 66 | 146 | 125 | 66 | 51 |
| Viscosity after F/T cycle [cP]^{h} | 1460 | 1178 | 998 | 1020 | 67 |

^{a}Proxel GXL, 20% aqueous dipropylene glycol solution of 1,2-benzisothiazolin-3-one, supplied by Lonza. This material is part of the dispersion that is made per the process parameters of Table 1 and is not added at another point in the process.
^{b}isomers of bis-(2-hydroxypropyl)-dimethylammonium methylsulfate fatty acid ester. This material is part of the dispersion that is made per the process parameters of Table 1 and is not added at another point in the process. The iodine value of the parent fatty acid is about 36. The material as obtained from Evonik contains impurities in the form of free fatty acid, the monoester form of bis-(2-hydroxypropyl)-dimethylammonium methylsulfate fatty acid ester, and fatty acid esters of bis-(2-hydroxypropyl)-methylamine.
^{c}MP10 ®, supplied by Dow Corning, 8% activity
^{d}as described in U.S. Pat. No. 8,765,659, expressed as 100% encapsulated perfume oil
^{e}Rheovis ® CDE, cationic polymeric thickener supplied by BASF
^{f}The nonionic level is calculated based on 100% activity.
^{g}Brookfield ® DV-E viscosity in cP, at 60 rpm, at about 20° C., 24 hours after making
^{h}Brookfield ® DV-E viscosity in cP, at 60 rpm, at about 20° C., after a freeze-thaw cycle

TABLE 2
examples of ethoxylated nonionic surfactants

| | | average # | |
|---|---|---|---|
| | | ethylene oxide | Nonionic |
| Ethoxylated | | groups according | structure |
| nonionic | | to the supplier's | Linear/ |
| surfactant | Supplier | literature | Branched |
| Emulan HE 50 | BASF | 5 | Linear |
| Tergitol 15-S-7 | The Dow Chemical | 7 | Branched |
| | Company | | |
| Tergitol 15-S-15 | The Dow Chemical | 15 | Branched |
| | Company | | |
| Lorodac 20-24 | Sasol | 20 | Linear |
| Tergitol 15-S-20 | The Dow Chemical | 20 | Branched |
| | Company | | |

Compositions with a viscosity higher than 700 cP after a freeze-thaw (F/T) cycle can be considered not fit for use anymore as these high viscosities can result in inaccurate and messy dosing as well as dispenser residues in the washing mahine While nonionic surfactants have been used in the past to improve F/T stability, comparative examples 1-4 illustrate that compositions comprising perfume oil are still prone to dramatic viscosity increases after a F/T cycle. Examples 5, comprising a branched surfactant according to Formala A, illustrate that the F/T stability was well maintained. Comparison of comparative Example 1 with Example 5 illustrates that the branching of the nonionic surfactant is required to provide F/T stability. Comparison of comparative Example 4 with Example 5 indicates that the average degree of ethoxylation higher than 15 is required to provide F/T stability.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric enhancer composition having a viscosity of from about 20 cP to about 700 cP and a pH of from about 1 to about 5, said fabric enhancer composition comprising, based on total composition weight:
a) from about 3% to about 20% of a quaternary ammonium ester fabric softening active;
b) from about 0.01% to about 30% of an alcohol comprising from 1 to 7 carbons;
c) from about 0.1% to about 10% of a perfume delivery system and/or from about 0.1% to about 4% perfume oil;
d) a surfactant having Formula A and/or B: 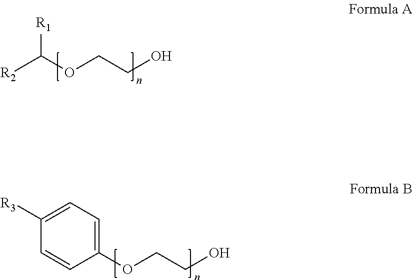
wherein n is on average greater than 15 and smaller than 30, R₁ is a linear or a branched alkyl group comprising from 1 to 21 carbons, or R₁ is a hydrogen; R₂ is a linear or branched alkyl group comprising from 1 to 22 carbon atoms, with the proviso that the sum of the total number of carbon atoms of R₁ and R2 is from 9 to 22; with the proviso when R₁ is a hydrogen R₂ is a branched alkyl group; R₃ is a linear or branched alkyl group comprising from 9 to 22 carbon atoms;
the ratio of quaternary ammonium ester softener active to nonionic surfactant being about 1:1 to about 10:1.

2. A fabric enhancer composition according to claim 1, having a viscosity of about 40 cP to about 600 cP, and a pH of from about 2 to about 4, said fabric enhancer composition comprising, based on total composition weight:
a) from about 4% to about 15% of a quaternary ammonium ester fabric softening active;
b) from about 0.1% to about 30%, of an alcohol comprising from 1 to 7 carbons; and
d) a surfactant having Formula A and/or B: 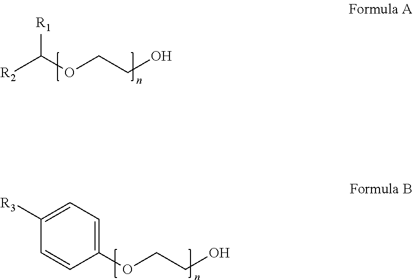
wherein n is on average from about 16 to 29; R₁ a linear or branched alkyl group comprising from 1 to 21 carbons; R₂ is a linear or branched alkyl group comprising from 1 to 22 carbon atoms, with the proviso that the sum of the total number of carbon atoms of R₁ and R₂ is from 9 to 22; R₃ is a linear or branched alkyl group comprising from 9 to 22 carbon atoms;
the ratio of quaternary ammonium ester softener active to nonionic surfactant being about 2:1 to about 13:2.

3. A fabric enhancer according to claim 1, wherein said alcohol is selected from the group consisting of a mono alcohol, polyol and mixtures thereof.

4. A fabric enhancer according to claim 1, wherein said alcohol is selected from the group consisting of ethanol, isopropanol, glycerol, ethylene glycol, propanediol, sorbitol and mixtures thereof.

5. A fabric enhancer according to claim 1, wherein said fabric enhancer composition comprises, based on total composition weight, from 1.1% to about 5% of said nonionic surfactant.

6. A fabric enhancer composition according to claim 1, wherein the surfactant has Formula A, wherein n is on average from about 16 to 29; R₁ is a linear or branched alkyl group comprising from 1 to 21 carbons; R₂ is an alkyl group comprising from 1 to 22 carbon atoms, with the proviso that the sum of the total number of carbon atoms of R₁ and R₂ is from 9 to 22.

7. A fabric enhancer composition according to claim 1, wherein the surfactant has Formula A, wherein n is on average from about 20 to 29.

8. A fabric enhancer composition according to claim 7, wherein n is on average about 20.

9. A fabric enhancer composition according to claim 1, wherein the surfactant has Formula B, wherein R3 is a branched alkyl group comprising 9 carbon atoms.

10. A fabric enhancer composition according to claim 1, wherein said fabric softening active quaternary ammonium ester has the following formula:
{R²₄₋ₘ—N⁺—[X—Y—R¹]ₘ}A⁻
wherein:
m is 1, 2 or 3 with proviso that the value of each m is identical;
each R¹ is independently hydrocarbyl, or substituted hydrocarbyl group;
each R² is independently a C₁-C₃ alkyl or hydroxyalkyl group;
each X is independently (CH₂)n, CH₂—CH(CH₃)— or CH—(CH₃)—CH₂— and
each n is independently 1, 2, 3 or 4;
each Y is independently —O—(O)C— or —C(O)—O—;
A− is independently selected from the group consisting of chloride, methylsulfate, ethylsulfate, and sulfate;
with the proviso that the sum of carbons in each R¹, when Y is —O—(O)C—, is from 13 to 21.

11. A fabric enhancer composition according to claim 1, wherein said quaternary ammonium ester fabric softening active comprises a fatty acid moiety comprising 12 to 22 carbons, said quaternary ammonium esters being selected from the group consisting of:
a) bis-(2-hydroxypropyl)-dimethylammonium methylsulfate fatty acid ester;
b) isomers of bis-(2-hydroxypropyl)-dimethylammonium methylsulfate fatty acid ester;
c) N,N-bis(hydroxyethyl)-N,N-dimethyl ammonium chloride fatty acid ester;
d) N,N-bis(hydroxyethyl)-N,N-dimethyl ammonium methylsulfate fatty acid ester; and
e) N,N,N-tri(2-hydroxyethyl)-N-methyl ammonium methylsulfate fatty acid ester;
said quaternary ammonium ester fabric softening active's fatty acid ester moiety being saturated or unsaturated, and substituted or unsubstituted.

12. A fabric enhancer composition according to claim 1, wherein the parent fatty acid moiety of said quaternary ammonium ester fabric softening active is:
a) saturated, substituted and of animal origin;
b) saturated, substituted and of vegetable origin;
c) saturated, unsubstituted and of animal origin;
d) saturated, unsubstituted and of vegetable origin;
e) unsaturated, substituted and of animal origin;
f) unsaturated, substituted and of vegetable origin;
g) unsaturated, unsubstituted and of animal origin; or
h) unsaturated, unsubstituted and of vegetable origin.

13. A fabric enhancer composition according to claim 1, wherein said quaternary ammonium ester fabric softening active has an iodine value from 0 to about 60.

14. A fabric enhancer composition according to claim 1, wherein said quaternary ammonium ester fabric softening active has the following formula:
{[R²]₂N⁺[CH₂—CH(CH₃)—O—C(═O)—R¹]₂}A⁻
wherein each R² is independently hydrogen, a short chain C₁-C₆ alkyl, C₁-C₃ hydroxyalkyl group, a poly(C₂₋₃ alkoxy), benzyl, or mixtures thereof,
wherein each R¹ is independently a hydrocarbyl group or substituted hydrocarbyl group comprising about 11 to about 21 carbon atoms,
and wherein A⁻ is selected from the group consisting of chloride and methylsulfate.

15. A fabric enhancer composition according to claim 1, wherein said perfume delivery system is selected from the group consisting of benefit agent delivery particles, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof.

16. A fabric enhancer composition according to claim 1, wherein said perfume delivery system comprises benefit agent containing delivery particles.

17. A fabric enhancer composition according to claim 16, wherein said perfume delivery system comprises two or more types of benefit agent containing delivery particles.

18. A method of treating and/or cleaning a fabric, said method comprising
a) optionally washing, rinsing and/or drying said fabric;
b) contacting said fabric with a fabric enhancer composition according to claim 1, and
c) optionally washing, rinsing and/or drying said fabric wherein said drying steps comprise active drying and/or passive drying.
